(19) United States
(12) Patent Application Publication
(10) Pub. No.: US 2024/0323638 A1
(43) Pub. Date: Sep. 26, 2024

(54) Method And Loudspeaker System For Processing An Input Audio Signal

(71) Applicant: Soundfocus ApS, Risskov (DK)

(72) Inventors: Søren Henningsen Nielsen, Aarhus N (DK); Kim Rishøj Pedersen, Egå (DK)

(73) Assignee: Soundfocus ApS, Risskov (DK)

(21) Appl. No.: 18/577,630

(22) PCT Filed: Jul. 9, 2021
(86) PCT No.: PCT/DK2021/050233

§ 371 Date: Jan. 8, 2024

(51) Int. Cl. H04S 7/00; H04R 5/02

(52) U.S. Cl. CPC H04S 7/307; H04R 5/02; H04S 2400/13; H04S 2400/15

(57) ABSTRACT

The invention relates to a method for processing an input audio signal to be perceived in an acoustical environment comprising at least a first sound zone and a second sound zone, comprising the steps of receiving an input audio signal, processing said input audio signal using signal processing to generate a processed audio signal, determining an expected loudness in a second sound zone of said acoustical environment, of acoustically reproducing said processed audio signal by a loudspeaker system for a first sound zone of said acoustical environment, wherein said determining an expected loudness is at least with respect to a bass frequency band; and automatically adjusting, on the basis of said determined expected loudness in said second sound zone, one or more level-dependent filters of said processing. The invention further relates to a loudspeaker system for processing an input audio signal to be perceived in an acoustical environment.

### FIELD OF THE INVENTION

The present invention relates to a method for processing an input audio signal to be perceived in an acoustical environment comprising at least a first sound zone and a second sound zone. The invention further relates to a loudspeaker system for processing an input audio signal to be perceived in an acoustical environment.

### BACKGROUND OF THE INVENTION

When an audio signal is reproduced by a loudspeaker as acoustic sound the signal permeates the acoustical environment in which the loudspeaker is present. Thereby listeners present within the acoustical environment may perceive the content of the audio signal.

However, sometimes it is desirable that only certain people in the acoustical environment may perceive the signal whereas the other people in the acoustical environment, who are not intended listeners of the audio signal, are left undisturbed.

To some extent this may be realized by only targeting specific area(s) of the acoustical environment with acoustic sound from a loudspeaker. However, due to the physical nature of sound waves, undesired sound may still leak into other unintended areas of the acoustical environment which may be of great annoyance to the non-intended listeners.

### SUMMARY OF THE INVENTION

The inventors have identified the above-mentioned problems and challenges related to sound leakage, and subsequently made the below-described invention which may reduce the audible impact of sound leakage.

An aspect of the invention relates to a method for processing an input audio signal to be perceived in an acoustical environment comprising at least a first sound zone and a second sound zone, said method comprising the steps of:
receiving an input audio signal;
processing said input audio signal using signal processing to generate a processed audio signal;
determining an expected loudness in a second sound zone of said acoustical environment, of acoustically reproducing said processed audio signal by a loudspeaker system for a first sound zone of said acoustical environment, wherein said determining an expected loudness is at least with respect to a bass frequency band; and
automatically adjusting, on the basis of said determined expected loudness in said second sound zone, one or more level-dependent filters of said processing.

The method of the present invention for an audio signal to be perceived in an acoustical environment provides an advantageous way of acoustically reproducing an audio signal for one or more intended listener(s) in a sound zone. Typically, when an audio signal is acoustically reproduced for an intended listener present in an acoustical environment, the audio signal may also be perceived by other people present in the same acoustical environment who are not intended listeners of that sound. This may of course lead to great annoyance for the people who are not intended listeners of the audio signal.

The above-described problem may also be referred to as leakage of sound from a first sound zone, where it is desired to listen to the audio signal, into a second sound zone, where it is not desired to listen to that audio signal. Such leakage of sound is particularly a problem for low-frequency sounds, since it is difficult to control the directionality of low-frequency sounds in most audio systems. This difficulty is generally attributed to the long wavelength of low-frequency sounds which hampers directional perception of sound. The fact that humans listen with two ears that are spatially separated is important in understanding how the directionality of sound is perceived by humans. At high frequencies, the human head may shadow the sound source and it becomes easy to sense the direction of sound. In the midrange and upper low frequencies, the sound reaches each ear at a different point in time, and this is how directionality is discerned. However, below a certain frequency the sound waves become so long that the human perception of directionality is greatly hampered.

Further, when the dimensions of sound sources such as loudspeakers, and/or the relative position of several sound sources, become comparable to the wavelengths of low frequency sound waves, they become omnidirectional. For low frequency audio, the room dimensions and properties also affect perceived directionality as room dimensions typically are comparable to the wavelength of low frequency sounds. As an example, a 50 Hz sound signal has a wavelength of about 7 m, which is comparable to distances between e.g., opposing walls of a room.

The method of the present invention may provide a way of addressing the abovementioned problem relating to leakage of low-frequency sound from a first sound zone to a second sound zone, by removing/reducing the audible impact of the reproduced audio signal in the second sound zone, thereby ensuring that primarily only intended listeners perceive the input audio signal. This, however, does not necessarily imply that certain frequency components of the input audio signal are not reproduced at all, but instead that the reproduction of the input audio signal takes into account the human perception of sound, i.e., the loudness experienced by a listener instead of the physical sound pressure level present. In other words, according to the invention, the reproduced audio signal may still be present in the second sound zone, but ideally it may be present at a sound pressure level where human perception of the signal is very low or even non-existing.

By determining an expected loudness in a second sound zone resulting from a reproduction of a processed audio signal in a first sound zone, at least with respect to the bass frequency band, and then automatically adjusting level-dependent filters concerned with processing of the input audio signal on the basis of the determined expected loudness, it may be possible to reduce the undesired perception of at least low-frequency content of the reproduced audio signal in the second sound zone. The automatic adjustment of the filters of the processing may ensure that the reproduced audio signal is kept at a sound pressure level, in at least the bass frequency band, which is low enough given the acoustical conditions of the second sound zone, such that the reproduced audio signal is not perceived, or at least substantially not perceived, within the second sound zone.

The above method is therefore advantageous in that the reproduction of the audio signal in the first sound zone may then cause less disturbance to people that are not intended listeners of the input audio signal.

In the context of the present invention, an “input audio signal” is understood as any kind of electrical audio signal intended for reproduction. The input audio signal may be an analogue or a digital audio signal. The input audio signal may include any type of audio content to be reproduced, such as speech, music, and other kinds of sounds, e.g., sound alerts and notifications. The input audio signal may for example contain therapeutic music intended to alleviate a physical, emotional, or mental concern.

In the context of the present invention, “processing” is understood as any kind of audio processing, such as digital audio processing, arranged to perform operations on an audio signal to produce a modified audio signal, e.g., a processed audio signal. The processing may comprise analysis of the audio signals and application of filters, such as frequency filters, to the audio signal. The processing may for example comprise frequency-dependent level control and/or other kinds of filtering. In the context of the present invention, a “processed audio signal” is understood as any audio signal which is based upon, or derived from, the input audio signal. The processed audio signal may be regarded as a representation of the input audio signal, in the sense that it substantially contains the same signal content as the input audio signal irrespective of the fact that the two signals may not contain exactly the same frequency components. For example, the processed audio signal may contain fewer harmonics in a bass frequency band according to an embodiment of the invention.

In the context of the present invention, a “sound zone” is understood as a spatially limited region inside a space or environment, which may serve various purposes regarding sound reproduction. For example, a sound zone may be a zone in which an audio signal is targeted for reproduction, such as the reproduction of a music track or the audio part of a TV show, however, a sound zone may also be a zone in which silence is preferred, i.e., leakage of sound from other neighbouring sound zones must be minimized. Sound zones may be delimited by physical boundaries such as walls or curtains, but a single room without barriers can also comprise two or more sound zones separated by nothing else than air. A sound zone may for example be defined by its boundaries, e.g., walls, or by a central part, e.g., a couch, a bed, a table, a person, etc. In an example, two rooms sufficiently close to allow sound leakage could be two different sound zones in the same acoustic environment. In another example, one room could comprise two or more different sound zones, e.g., one around a desktop and another around a TV set, or one around each bed in a four-bed hospital room, or one around each person in the room.

In the context of the present invention, an “acoustical environment” is understood as an acoustic space in which sound can be perceived by a listener. The physical layout and properties of the acoustic environment may affect the acoustics by e.g., improving the quality of the sound or interfere with the sound. These properties may be reflections with boundaries of the acoustic environment such as walls, floors, and ceilings, and objects present within the acoustic environment such as structural elements, furniture, and people, or diffraction caused by interaction of sound with the boundaries and objects. For example, an acoustic environment may be a closed environment such as a room of a residential housing, a museum, a theatre, a restaurant, an office environment, such as a landscaped office, or an open environment, such as a venue for an open-air concert or a sports event. The acoustic environment is further understood as an environment in which sound reproduced for one sound zone may be perceived in another sound zone, and vice versa. In other words, an acoustic environment may comprise a number of sound zones.

In the context of the present invention, a “loudspeaker system” is understood as any kind of system capable of reproducing an input audio as acoustic soundwaves. The loudspeaker system may comprise any number of transducers, e.g., loudspeaker units, and amplifiers, such as a plurality of transducers and amplifiers.

In the context of the present invention, a “loudness” is understood as the subjective perception of sound pressure and is typically expressed in units of sone. The physical characteristics of sound waves are related to the perception of these sound waves by a listener. For any given frequency, the greater the amplitude of the sound wave, or sound pressure level, the greater the perceived loudness. The relationship between sound pressure and loudness is not a simple one as it may vary from one person to another person due to differences in the human ear. Furthermore, the human ear is not equally sensitive to all frequencies in the audible frequency range, thus a sound at one frequency may be perceived louder than one of equal sound pressure level at a different frequency. Although loudness is a subjective parameter, several standards to define loudness exist, and makes it possible to determine and compare loudness. Often such standards define loudness based on a conversion from e.g., sound pressure level using weighting filter such a A-weighting or LKFS, to compensate for the frequency-dependent human perception. In the context of the invention, determining expected loudness may thus for example be performed by determining expected sound pressure level and convert to loudness according to one of the loudness standards e.g., using a weighting filter. The expected sound pressure level or expected loudness may be based on knowledge of the processed audio signal to be reproduced and knowledge about the loudspeaker system reproducing it, e.g., a transfer function of the loudspeaker system. Further, information about the acoustic environment and the sound zones, in particular their transfer functions and mutual acoustic coupling, may be utilized in determining expected loudness.

The expected loudness may be a loudness determined in accordance with a standard such as ITU-R BS.1770, which refer to the relative loudness of different segments of electronically reproduced sounds, such as for broadcasting and cinema, or standards such as ISO 532A (Stevens loudness, measured in sones), ISO 532B (Zwicker loudness), or even DIN 45631 and ASA/ANSI S3.4 which have a more general scope and are often used to characterize loudness of environmental noise. The expected loudness may also be determined in accordance with more modern standards such as Nordtest ACOU112 and ISO/AWI 532-3, which take into account other components of loudness such as onset rate, time variation, and spectral masking.

Furthermore, by an “expected loudness” may be understood a predicted or an estimated loudness. Irrespective of whether a sound pressure level is measured/recorded in the second sound zone, or a transfer function is used to estimate the sound pressure level, loudness is a subjective phenomenon, and therefore loudness determined on the basis of a sound pressure level will always be prediction/estimation of the actual loudness experienced by a listener subjected to the sound.

In the context of the present invention, a “bass frequency band” is understood as a range of frequencies of sound comprising the tones of low frequency, i.e., the frequencies of sound that are concentrated around the lower end of audible sound, which generally for the human ear are frequencies of between 20 Hz and 20,000 Hz. As an example, the E-string of a bass guitar vibrates at about 41 Hz which corresponds to a lower range of audible frequencies. It is further noted that a bass frequency range is only a reference to a range of frequencies, and not as such a range of frequencies pertaining to any specific audio signal. In the context of the present invention, a relevant “bass frequency band” may be selected in accordance with the directionality properties of the loudspeaker system, the degree of acoustic coupling between the first sound zone and the second sound zone and the arrangement/dimensions of the respective sound zones. For example, the bass frequency band may be considered frequencies below 700 Hz, such as below 300 Hz.

In the context of the present invention, adjusting one or more level-dependent filters may include selecting any filter among a plurality of filters and/or adjusting one or more parameters of a filter, such as adjusting amplification at one or more frequencies or adjusting a cut-off frequency of a high-pass filter.

According to an embodiment of the invention said method comprises a step of determining a second expected loudness of acoustic sound present in said second sound zone.

In the context of the present invention, “acoustic sound” should be understood as sound that is different from the sound arising from reproduction of the input audio signal. The acoustic sound may be acoustic noise or it may be sound arising from acoustic reproduction of another audio signal than the first input audio signal. This, however, does not exclude that the acoustic sound may also originate from the loudspeaker system itself. In fact, according to an embodiment of the invention, the loudspeaker system may reproduce an audio signal, in the form of a masking signal, which is specifically targeting the second sound zone.

It is advantageous to determine the second expected loudness because it may then be possible to take into account any masking effect provided by the acoustic sound when processing the input audio signal. Masking refers to the fact that a sound component becomes inaudible due to the presence of other frequency components. Normal hearing humans can hear every frequency component of sound if no other noise is present, however, the perception threshold of this component can change in the presence of a masking signal which in the present disclosure may also simply be referred to as a “masker”.

Specifically, a masker may be used to impact the threshold of audibility which for any given sound frequency is the lowest sound pressure level that may be perceived by the human ear. A masking signal which is centred about any given sound frequency may impact the audibility of another signal at that frequency, such that the other signal has to be present at a higher sound pressure level in order to be perceived by a listener. Consequently, a masking signal which is reproduced at an adequately high sound pressure level compared to the sound pressure level of another signal may provide a masking effect on that other signal such that the other signal may become difficult to perceive by a listener, and in some cases not perceivable at all by that listener.

The masking effect is not necessarily limited to cases where a dedicated masking signal is provided, but also in general for cases where any other acoustic sound signal is present. This is best explained using the following example which is an example of a use case of a method according to an embodiment of the invention.

In this example the acoustical environment is a hospital bed ward, and the first and second sound zones are two neighbouring bed spaces within that bed ward. A patient present in the first sound zone may be subjected to therapeutic music from a loudspeaker system present in the bed ward, however, the other patient present in the second sound zone would like to listen to the sound from his/her television without listening to the therapeutic music. In this case, the sound from the television may actually act as a masker in the second sound zone, and the therapeutic music, which is present in the second sound zone due to the beforementioned sound leakage, may be masked to some extent by the sound from the television depending on the relative sound pressure level between the two signals.

Therefore, by determining the second expected loudness of the acoustic sound, in this example the television sound, it may be possible to adjust the processing of the input audio signal, in this example the therapeutic music, such that the reproduced audio signal is masked by the acoustic sound as effectively as possible. Thereby the patient in the second sound zone will have a more difficult time of perceiving the therapeutic music. Put in other words, the masker may increase the threshold of audibility of the reproduced processed audio signal in the second sound zone to higher sound pressure levels.

Determining the second expected loudness is also advantageous in that the masking effect provided by the acoustic sound may be utilized to achieve an improved sound reproduction in the first sound zone. The masking effect may ensure that the reproduced audio signal targeting the first sound zone may be at a higher sound pressure level within the first sound zone as compared to the situation where no masking signal is present in the second sound zone and the reproduced audio signal has to be at a lower sound pressure level to avoid excessive sound leakage. This ensures, for example, that the patient in the first sound zone may have the loudspeaker system playing the therapeutic music at the highest possible sound pressure level in the first sound zone, without disturbing the other patient in the second sound zone.

According to an embodiment of the invention said acoustic sound present in said second sound zone is produced by a foreign audio source different from said loudspeaker system.

The acoustic sound present in the second sound zone may be produced by a foreign audio source different from the loudspeaker system. In that sense, the acoustic sound may originate from a sound source that is not controllable with respect to the provisions of the present method. Such an audio source may e.g., be a further loudspeaker system, a radio, a television, a domestic appliance, other electronic equipment, passing traffic, conversation, etc.

According to an embodiment of the invention said acoustic sound present in said second sound zone is produced by said loudspeaker system on the basis of a received second input audio signal.

The loudspeaker system may be arranged to receive two or more input audio signals, such as the input audio signal and a further input audio signal, e.g., a second input audio signal. Thereby, the same loudspeaker system may reproduce sound signals for the first sound zone and the second sound zone. The two input audio signals may be different, with respect to signal content, and may reproduced for the two sound zones respectively, such that the first input audio signal is targeting the first sound zone and the second input audio signal is targeting the second sound zone.

According to an embodiment of the invention said second expected loudness is determined for reproducing of said received second input audio signal for said second sound zone by said loudspeaker system.

The second expected loudness may be determined using similar means for determining the expected loudness, including recording(s) using e.g., a microphone or by relying on an acoustic transfer function from the loudspeaker system to the second sound zone.

According to an embodiment of the invention said second input audio signal is a masking signal.

The second input audio signal may be a dedicated masking signal arranged to provide a masking effect in the second sound zone, thereby ensuring that a listener present in the second sound zone is less affected by sound leakage from the first sound zone into the second sound zone. The masking signal may be provided on the basis of the signal content of the first input audio signal and be adapted thereto to achieve an improved masking effect in the second sound zone.

A masking signal is also advantageous in that it affects the loudness as a function of physical level such that it only takes a small change in physical level to change the perceived loudness considerably. This in turn means that when using a masking signal, it may only be necessary to reduce the sound pressure level of the reproduced audio signal very slightly in order for the signal to not be perceived at all by a listener present in the second sound zone.

According to an embodiment of the invention said masking signal comprises pink noise.

The masking signal may comprise pink noise, commonly referred to as 1/f noise. Similar to white noise, pink noise is made up of various frequencies but with two major differences. Pink noise delivers less intensity in the higher frequencies and more intensity at the lower end of the spectrum. Pink noise is furthermore characterized by exhibiting an equal power in frequency bands that are proportionally wide. This means that pink noise would have equal power in the frequency range from 40 Hz to 60 Hz as in the frequency range from 4 kHz to 6 kHz. Pink noise is advantageous in that it is calibrated to sound balanced to the human ear; the tone has reduced high pitch sounds, is deeper overall and more pleasant.

According to an embodiment of the invention said automatically adjusting one or more level-dependent filters is further based on said second expected loudness level.

Automatically adjusting the one or more level-dependent filters based on the second expected loudness level is advantageous in that the reproduction of the processed audio signal may be at an optimal sound pressure level within the second sound zone such that it may be masked by the acoustic sound present in the second sound zone. Thereby the adjusting of the level-dependent filters may ensure an optimal balance between a good listening experience in the first sound zone and an appropriate level of sound leakage into the second sound zone.

According to an embodiment of the invention said processed audio signal is acoustically reproduced in said acoustical environment by said loudspeaker system as a reproduced processed audio signal.

Thereby a processed version of the input audio signal may be acoustically reproduced in the acoustical environment. By virtue of the processing of the input audio signal, it is primarily the intended listener(s) within the acoustical environment, such as the second sound zone, that perceive the reproduced audio signal, whereas other persons present in the acoustical environment that are not intended listeners do not perceive, or at least does not substantially perceive, the reproduced audio signal.

According to an embodiment of the invention said reproducing of said processed audio signal is targeting said first sound zone.

Thereby a processed version of the input audio signal may be acoustically reproduced specifically targeting the first sound zone. By virtue of the processing of the input audio signal, it is primarily the intended listener(s) within the first sound zone that perceive the reproduced audio signal.

According to an embodiment of the invention said reproducing of said processed audio signal is performed prior to said step of determining said expected loudness.

Thereby at least a sample of the processed audio signal may be reproduced in e.g., the acoustical environment, such as a sound zone thereof, prior to determining the expected loudness. This, however, does not preclude that further reproduction of the processed audio signal is performed after the step of determining the expected loudness. Reproducing the processed audio signal prior to determining the expected loudness is advantageous in at least the case when the expected loudness is determined on the basis of one or more measurements/recordings of the reproduced audio signal. In this way, a closed loop processing of the input audio signal may be realized, in which the one or more level-dependent filters are automatically adjusted based on the expected loudness stemming from the reproduction of the processed audio signal, such as an expected loudness determined by measurements/recordings.

According to an embodiment of the invention said reproducing of said processed audio signal is performed after said step of automatically adjusting one or more level-dependent filters of said processing.

Thereby the processed audio signal may be reproduced in e.g., the acoustical environment, such as a sound zone thereof, after determining the expected loudness. This, however, does not preclude that at least a sample of the input audio signal is reproduced prior to the automatic adjustment of the one or more level-dependent filters. Reproducing the processed audio signal after the step of automatically adjusting the one or more level-dependent filters is advantageous in that the reproduction of the audio signal may be highly controlled from the initial reproduction of the audio signal, and disturbing sounds, for non-intended listeners, may be avoided in the beginning of the reproduction. In this way, an open loop processing of the input audio signal may be realized, in which the one or more level-dependent filters are automatically adjusted based on the expected loudness which results from the reproduction of the resulting processed audio signal, such as an expected loudness which is estimated using e.g., an acoustic transfer function.

According to an embodiment of the invention said processed audio signal is first reproduced at a first sound pressure level in said first sound zone and subsequently reproduced at a second sound pressure level in said first sound zone, wherein said second sound pressure level is different from said first sound pressure level.

In the case of a closed loop processing of the input audio signal, which may rely on one or more recordings of the reproduced audio signal, the reproduction may first be at a predetermined sound pressure level with respect to the first sound zone, e.g., the first sound pressure level, and depending on a sound pressure level recorded, e.g., by a microphone in the second sound zone, it may be the case that the one or more level-dependent filters must be adjusted to e.g., reduce a sound pressure level with respect to the first sound zone as the level is too high in the second sound zone, or vice versa, increase a sound pressure level with respect to the first sound zone as the level is still well within acceptable levels in the second sound zone.

According to an embodiment of the invention said second sound pressure level is greater than said first sound pressure level.

The loudspeaker system may first reproduce the processed audio signal at a sound pressure level that is deliberately low before increasing the sound pressure level with respect to the first sound zone. This is advantageous in that sudden spikes in sound pressure level within the second sound zone may be avoided, and the sound pressure level may gradually be increased until an acceptable level has been reached with respect to the second sound zone.

According to an embodiment of the invention said expected loudness in said second sound zone is determined on the basis of one or more recordings of said reproduced audio signal, said one or more recordings being performed with respect to said second sound zone.

When recording said reproduced input audio signal it may not be possible to directly measure the loudness of the reproduced input audio signal since most recording devices, such as microphones, are only able to record physical attributes of acoustic sound waves, such as sound pressure level. However, the perceived loudness may be estimated/calculated based on recordings using various conversion models that are known to a skilled person, such as by use equal loudness contours often referred to as Fletcher-Munson curves.

Determining the expected loudness on the basis of one or more recordings performed with respect to the second sound zone is advantageous in that such recordings are true representations of the actual sound pressure level in the second sound zone, and therefore the expected loudness may be determined precisely with respect to the second sound zone. In this way, it may be possible to control the sound reproduction system without making too many assumptions about the sound reproduction system, such as about the frequency response of the loudspeaker system and acoustic transfer functions from the loudspeaker system to the second sound zone, and reverberations caused by objects/boundaries of the acoustical environment.

According to an embodiment of the invention said recording of said reproduced processed audio signal is performed using a microphone.

A microphone may be placed within the acoustical environment and measure a representation of sound pressure level of the processed audio signal reproduced by the loudspeaker. The microphone may be placed close to or within the second sound zone, such that recordings performed by the microphone are representative of the acoustic conditions in the second sound zone.

According to an embodiment of the invention said microphone is positioned within said second sound zone.

Placing the microphone within the second sound zone is advantageous in that the measurements/recordings by the microphone may represent, as best as possible, the actual sound pressure levels experienced in the second sound zone, and thereby the actual loudness experienced in the second sound zone.

According to an embodiment of the invention said expected loudness in said second sound zone is determined on the basis of an acoustic transfer function.

An acoustic transfer function is understood as any kind of function which defines a relationship between a sound pressure level at a source, and the sound pressure level at some remote point. By estimating, based on the acoustic transfer function, a sound pressure level in said second sound zone, it may be possible to determine a corresponding loudness in said second sound zone. The acoustic transfer function may be established on the basis of a modelling of said acoustic environment or on the basis of recordings performed within said acoustic environment. Using an acoustic transfer function as basis for determining loudness is advantageous in that the determination may be carried out without relying on equipment which need to be placed in the second sound zone, and thus the method of the present invention may be carried out using fewer system components.

The acoustic transfer function may take into account the acoustical environment, e.g., the layout of the acoustical environment and objects present therein, frequency responses of the loudspeaker system, and the processing of the input audio signal, comprising the level-dependent filters.

According to an embodiment of the invention said acoustic transfer function is established using a microphone.

The microphone may be used initially to establish a transfer function from the audio source, e.g., a transducer of the loudspeaker system to the position within the acoustical environment where the microphone is placed.

According to an embodiment of the invention said second expected loudness in said second sound zone is determined on the basis of one or more recordings of said acoustic sound present in said second sound zone, said one or more recordings being performed with respect to said second sound zone.

When recording said acoustic sound it may not be possible to directly measure the loudness of the acoustic sound since most recording devices, such as microphones, are only able to record physical attributes of acoustic sound waves, such as sound pressure level. However, the perceived loudness may be estimated/calculated based on recordings using various conversion models that are known to a skilled person, such as by use equal loudness contours often referred to as Fletcher-Munson curves.

Determining the second expected loudness on the basis of one or more recordings performed with respect to the second sound zone is advantageous in that such recordings are true representations of the actual sound pressure level in the second sound zone, and therefore the second expected loudness may be determined precisely with respect to the second sound zone.

According to an embodiment of the invention said recording of said acoustic sound is performed using a microphone.

A microphone may be placed within the acoustical environment and measure a representation of sound pressure level of the processed audio signal reproduced by the loudspeaker.

In an embodiment of the invention, the microphone for recording the acoustic sound may be the same microphone which is used for recording the reproduced processed audio signal.

According to an embodiment of the invention said bass frequency band comprises frequencies in the range of from 0 Hz to 700 Hz.

The bass frequency band may comprise frequencies in the range of from 0 Hz to 700 Hz, such as in the range of from 0 Hz to 500 Hz, such as in the range of from 0 Hz to 400 Hz, for example in the range of from 0 Hz to 300 Hz, such as in the range of from 20 Hz to 300 Hz. Since the hearing range is commonly given as from 20 Hz to 20 kHz, the bass frequency range may accordingly also designate frequencies of 20 Hz and greater, such as 20 Hz to 700 Hz, for example 20 Hz to 300 Hz. Frequencies below 20 Hz may consequently be filtered off and not considered as forming part of the bass frequency band.

According to an embodiment of the invention said adjusting one or more level-dependent filters comprises selecting a filter among a plurality of filters.

The adjusting of one or more level-dependent filters may include selecting between two different filters depending on the expected loudness: a first level-dependent filter which does not affect the input audio signal in the bass frequency band, and a second level-dependent filter in the form of a high pass filter which substantially allow frequencies above the bass frequency band to pass through, thereby effectively applying a reduced gain (between 0 and 1) to the input audio signal in the bass frequency band. Once the expected loudness in the second sound zone exceeds e.g., a threshold value the adjusting of one or more level-dependent filters may include changing filter from the first level-dependent filter to the second level-dependent filter. In this way it may be possible to address e.g., leakage of low frequency within the bass frequency band from the first sound zone to the second sound zone.

According to an embodiment of the invention said adjusting one or more level-dependent filters comprises adjusting one or more parameters of a filter.

The adjusting of one or more level dependent filters may include adjusting a parameter of a filter depending on the expected loudness. The filter may for example be a high pass filter with an adjustable cut-off frequency which may be adjusted on the basis of the expected loudness.

According to an embodiment of the invention said loudspeaker system comprises a loudspeaker array, said loudspeaker array comprising a plurality of transducers.

Using a loudspeaker array is advantageous in that a high directionality of the reproduced processed audio signal may be achieved and thereby problems relating to leakage of sound may be reduced further.

In the context of the present invention, a “loudspeaker array” is understood as any assembly of a plurality of transducers, such as loudspeakers, wherein the transducers are arranged in a specific configuration, such as in a 1-dimensional configuration, i.e., in a linear configuration in which the transducers are spaced apart along a line, or in a 2-dimensional configuration, e.g., in a grid with rows and columns of transducers, or in a random configuration. The loudspeaker array may indeed take on any configuration of the transducers, and the term “array” is not intended to place any limits on the possible geometrical distribution of the transducers.

According to an embodiment of the invention said loudspeaker array comprises one or more gradient loudspeakers.

One way to improve the directional control of a loudspeaker array is to let each loudspeaker in the loudspeaker array have a directional characteristic based on sound pressure gradient in addition to sound pressure. By letting each loudspeaker in the loudspeaker array have some degree of directional control due to application of pressure gradient loudspeakers, the ability to control the radiation characteristics at low frequencies can be improved compared to a transducer array comprising only pressure loudspeakers.

According to an embodiment of the invention said one or more gradient loudspeakers comprises one or more loudspeakers and gradient control elements.

In general, if two loudspeakers are separated by some distance and driven with signals of opposite polarity, and if the signal applied to the rear source is delayed by a length of time equal to the propagation time between the two loudspeakers, a desirable radiation pattern is produced at low frequencies. This radiation pattern projects sound with higher intensity in the forward direction and lower intensity in the rearward direction. A plot of the radiation intensity has the general shape of a heart, and because of that, is often referred to as a cardioid radiation pattern.

A similar result may actually be obtained using a single loudspeaker. The sound emanating from the back side of a vibrating diaphragm has inverse polarity relative to the sound emanating from the front side of the diaphragm. If the rear radiation is constrained by an enclosure but allowed to exit the enclosure through a port located at a distance from the origin of the front radiation; and, if the rear radiation is delayed by an appropriately designed acoustical system, then a cardioid radiation pattern may be produced over a limited bandwidth. Such a device is referred to as a passive cardioid loudspeaker.

In this way a gradient loudspeaker may be realized in a passive way, i.e., the gradient control is realized by implementing a gradient control element in the form of a port. Other gradient control elements known to the skilled person may also be utilized in order to realize a passive gradient loudspeaker, such as slits, ducts/channels, and/or foam.

According to an embodiment of the invention said one or more gradient loudspeaker comprises two oppositely facing loudspeakers.

Arranging two loudspeakers such that they are oppositely facing to one another is advantageous in that a first-order directional sound source is achieved. The basic directional characteristics of a single first-order directional sound source comprises three basic shapes: a) spherical, b) figure of eight, c) cardioid. For example, the spherical shape comprises only a pressure component and no pressure gradient component. The figure-of-eight shape, on the other hand, only comprises a pressure gradient component. The cardioid shape comprises both a pressure and a pressure gradient component.

According to an embodiment of the invention said two oppositely facing loudspeakers are separated by a baffle. Separating the two oppositely facing loudspeakers by a baffle is advantageous in that the efficiency of the loudspeakers at lower frequencies is higher than if the loudspeakers are placed on opposite sides of an enclosure.

According to an embodiment of the invention said step of acoustically reproducing said input audio signal comprises generating a plurality of driving signals, wherein each driving signal is generated for a respective transducer of said loudspeaker array.

In the context of the present invention, a “driving signal” is understood as an energy-carrying signal which, when applied to a transducer, causes the transducer to convert the electrical energy in the driving signal into acoustic sound energy, such as through actuation of a diaphragm.

According to an embodiment of the invention said processing said input audio signal comprises filtering harmonics in a directionally controllable frequency band, each of said harmonics corresponding to a lower order harmonic in a bass frequency band of said input audio signal, wherein said bass frequency band comprises frequencies below said directionally controllable frequency band.

Thereby is provided an advantageous way of processing the input audio signal which allows for an increased directional control of the reproduced audio signal which may further reduce the problems relating to leakage of sound.

A particular challenge of directionally reproducing an audio signal is that the low frequency content of the audio signal is difficult to control due to the relatively large wavelengths of sound associated with these frequencies.

The present method for directionally reproducing an audio signal provides an advantageous way of processing an audio signal which utilizes the fact that sound is perceived in a particular way by humans. A phenomenon called virtual pitch can be used to give a perception of a low-pitched signal, even without the fundamental frequency corresponding to the low pitch being present in the signal.

Pitch is an auditory sensation in which a listener assigns musical tones to relative positions on a musical scale based primarily on their perception of the frequency of vibration. Pitch is closely related to frequency, however the two are not equivalent. Frequency is an objective, scientific attribute that can be measured. Pitch, however, is a person's subjective perception of a sound wave, which cannot be measured. However, this does not necessarily mean that most people won't agree on which notes are higher and lower. Pitched musical instruments are often based on an acoustic resonator such as a string or a column of air, which oscillates at numerous modes simultaneously. At the frequencies of each vibrating mode, waves travel in both directions along the string or air column, reinforcing and cancelling each other to form standing waves. The interaction of these standing waves with the surrounding air causes audible sound waves, which travels away from the instrument. Because of the typical spacing of the resonances, these frequencies are mostly limited to integer multiples, or harmonics, of the lowest frequency, or the fundamental frequency, and such multiples form a harmonic series. The harmonics have an influence on the pitch. The musical pitch of a note is usually perceived as the lowest order harmonic present (the fundamental frequency, or simply the fundamental), which may be the one created by vibration over the full length of the string or air column, or a higher harmonic chosen by the player. The musical timbre of a steady tone from such an instrument is strongly affected by the relative strength of each harmonic.

The phenomenon of virtual pitch may particularly be utilized by filtering harmonics in a directionally controllable frequency band, where it becomes possible to represent low-frequency audio content of an input audio signal by correspondingly higher frequency harmonics and thereby possible to obtain a perception of low frequency sounds present in the input audio signal but not necessarily reproduced, or at least attenuated, by the loudspeaker system. This filtering of harmonics may also be regarded as bass substitution, i.e., substitution of low frequency sounds by higher order corresponding harmonics. This enables a listener, e.g., a person, to perceive the lower order harmonic in the bass frequency band even though this lower order harmonic is not as such reproduced by the transducer array. Performing such a bass substitution is highly advantageous since the substituted harmonics are at higher frequencies which are much easier to control the directionality of, and thereby problems relating to leakage of sound may be addressed. In the context of the present invention, a “harmonic” is understood as any member of a harmonic series. A harmonic is a sound wave that has a frequency that is an integer multiple of a fundamental tone. For a musical string, such as a bass string, fixed at both ends of the string, the fundamental tone, or fundamental frequency, f₁ may be expressed as

$${f}_{1} = \frac{v}{2 L}$$

where v is the speed of a transverse wave on the musical string, and L is the length of the string. The other standing-wave frequencies are ƒ₂=2v/2L, f₃=3v/2L, and so on. These higher order harmonics are all integer multiples of the fundamental frequency f₁ and are commonly referred to as overtones. The harmonic series for the musical string may be expressed as

$${f}_{n} = n \frac{v}{2 L} = n {f}_{1}$$

where n is any integer number (n=1,2,3, . . . ), and the lowest harmonic (n=1) in the series corresponds to the fundamental frequency.

The above example merely serves to illustrate the concept of a harmonic series for a given musical instrument. The harmonic series for an instrument depends on the type of boundary conditions for the standing waves of the instrument, and thus on the instrument playing. For example, an open organ pipe (open at both ends of the pipe) is characterized by harmonics having the type of n=1,2,3, . . . , whereas a closed organ pipe (open at one end of the pipe) is characterized by harmonics of the type n=1,3,5, . . . , where the fundamental frequency f₁ of the closed pipe is half of the fundamental frequency f₁ of the open pipe.

It is appropriate at this point to further elaborate on the meaning of harmonics. In the present disclosure the term “harmonic” refers to modes of vibration of a system that are whole-number multiples of a fundamental mode, and also to the sounds that they generate. However, it is customary to the skilled person to stretch the definition a bit so that it includes modes that are nearly whole-number multiples of the fundamental, for example 2.005 times the fundamental rather than 2. Thus, for the purpose of the present invention, the term “harmonics” encompasses both overtones that are perfect integer multiples of a fundamental, as well as overtones that are not exactly integer multiples of a fundamental. Such non-perfect harmonics may arise to e.g., stiffness in an instrument, for example due to a stiffness in a musical string.

In the context of the present invention, “filtering harmonics” is understood as processing of harmonics. Filtering harmonics may include selecting and/or providing, e.g., generating, harmonics of a harmonic series corresponding to lower order harmonics to be present in the processed audio signal. The filtering of harmonics may thus comprise selecting a subset of harmonics present in the input audio signal to be carried over in the processed audio signal and may further comprise generating harmonics in the processed audio signal, wherein the generated harmonics corresponds to harmonics in the input audio signal. Filtering harmonics is not as such understood as mitigating harmonics caused by electrical equipment, such as power supplies, although such mitigation may be advantageous, and contemplated by the present invention, if the input audio signal comprises such unwanted disturbances.

In the context of the present invention, a “directionally controllable frequency band” is understood as a range of frequencies of sound where the directionally of the sound is most easily controlled. It is further noted that a directionally controllable frequency range is only a reference to a range of frequencies, and not as such a range of frequencies pertaining to any specific audio signal.

According to an embodiment of the invention said processing said input audio signal comprises attenuating said bass frequency band of said input audio signal.

Attenuating the bass frequency band, i.e., reducing the level of low bass frequencies, is advantageous in that the directivity of the loudspeaker system may be improved. Reducing the physical level of low bass frequencies comes at a cost as the acoustical level of these low bass frequencies is reduced as well. However, this reduction may advantageously be compensated by filtering of harmonics according to an embodiment of the present invention.

According to an embodiment of the invention said processing said input audio signal uses a high-pass filter for said attenuation of said bass frequency band.

The bass frequency band may advantageously be attenuated by a high-pass filter. The high-pass filter may attenuate frequencies of the input audio signal present in the bass frequency band. A high-pass filter is advantageous in that it may be easily implemented in a signal processing of an audio signal.

According to an embodiment of the invention said filtering harmonics comprises representing one or more of said lower order harmonics by harmonics within said directionally controllable frequency band.

By representing lower order harmonics by harmonics within the directionally controllable frequency band is understood that harmonics present in the bass frequency band of the input audio signal are represented by, such as substituted by, higher order corresponding harmonics of a same harmonic series, the higher order harmonics being at higher frequencies than the bass frequency band, i.e., in the directionally controllable frequency band.

According to an embodiment of the invention said filtering harmonics comprises utilizing virtual pitch techniques.

By virtual pitch techniques are understood any kind of techniques which may provide the auditory sensation of virtual pitch as explained above.

According to an embodiment of the invention said filtering harmonics comprises increasing a gain of one or more harmonics within said directionally controllable frequency band.

Increasing a gain of one or more harmonics within said directionally controllable frequency band is advantageous in that a credible perception of low frequency content may be achieved. A harmonic present in the bass frequency band of the input audio signal may form part of a harmonic series comprising multiple harmonics, some of which are higher order harmonics present in the directionally controllable frequency band of the input audio signal. By increasing the gain of these higher order harmonics, such as by increasing with a common gain, it may be possible to maintain a timbre of the input audio signal. This is particular advantageous in combination with an attenuation of the bass frequency band, as an improved bass substitution may then be realized.

According to an embodiment of the invention said filtering harmonics comprises generating one or more harmonics in said directionally controllable frequency band on the basis of one or more of said lower order harmonics.

Higher order harmonics corresponding to frequencies in the directionally controllable frequency band may be generated on the basis of one or more lower order harmonics, such as a fundamental, in the bass frequency band of the input audio signal. This is advantageous in that a simple audio processing is required as the generation of higher order harmonics may be produced using simple non-linear functions such as square, cubic and/or exponential functions.

According to an embodiment of the invention said filtering harmonics comprises frequency shifting one or more of said lower order harmonics of said bass frequency band to said directionally controllable frequency band.

By frequency shifting is understood shifting frequencies, such as lower order harmonics present in the bass frequency band, by a common frequency amount. That is, a frequency ƒₖ may be shifted by an amount λ to ƒₖ+λ. The amount λ may advantageously be equal to the frequency of one of the harmonics, otherwise the shift may alter the ratio of the harmonics and make an inharmonic sound.

According to an embodiment of the invention said step of generating a plurality of driving signals further comprises gradient processing.

By gradient processing is understood the processing of a signal for use in a gradient loudspeaker. This is particularly suitable if the loudspeaker system comprises transducers arranged as gradient loudspeakers. Using gradient processing it becomes possible to produce a sound signal having a radiation characteristic of the cardioid type.

According to an embodiment of the invention said first sound zone and said second sound zone are acoustically coupled sound zones.

In the context of the present invention, “acoustically coupled” refers to the two sound zones being arranged such that sound produced in one sound zone may leak into the other zone, and vice versa. Two sound zones may be acoustically coupled in spite of obstructions being present between the two zones. Such obstructions may include physical borders such as walls, curtains and other dividers, as well as objects present within the acoustical environment.

According to an embodiment of the invention said first sound zone and said second sound zone are spatially arranged in said acoustic environment.

The two sound zones may each form part of an acoustical environment. For example, the two sound zones may be different regions of a room.

According to an embodiment of the invention said first sound zone and said second sound zone are spatially non-overlapping.

According to an embodiment of the invention said first sound zone and/or said second sound zone are adaptive sound zones.

In the context of the present invention, an “adaptive sound zone” is understood as a sound zone the spatial location of which may change over time. Such an adaptive sound zone is particular advantageous when a listener to the audio signal is moving relative to the transducer array. In this way the listener may experience the same listening experience irrespective of the fact that the listener is moving through e.g., a room in which the transducer array is installed.

According to an embodiment of the invention said input audio signal is a first input audio signal, said processed audio signal is a first processed audio signal, and wherein said method further comprises the steps of:
receiving a second input audio signal;
processing said second input audio signal by signal processing to generate a second processed audio signal;
determining an expected loudness in said first sound zone of said acoustical environment, of reproducing said second processed audio signal by said loudspeaker system for said second sound zone of said acoustical environment, wherein said determining an expected loudness is at least with respect to a bass frequency band, and
automatically adjusting, on the basis of said determined expected loudness in said first sound zone, one or more level-dependent filters of said processing.

The method may further include the provision of processing a second input audio signal and determining an expected loudness in the first sound zone of reproducing the signal for the second sound zone. Thereby is provided an advantageous method which allows two different input audio signals to be reproduced for two respective sound zones, by the same loudspeaker system, while alleviating the problems of sound leakage from one sound zone in to the other, and vice versa.

The step of processing of the second input audio signal may be carried out similarly to any of the above provisions relating to the processing of the first input audio signal. The step of determining an expected loudness in the first sound zone may be carried out similarly to any of the above provisions relating to the determining an expected loudness in the second sound zone. The step of automatically adjusting, on the basis of said determined expected loudness in said first sound, one or more level-dependent filters of said processing similarly to any of the above provisions relating to automatically adjusting, on the basis of said determined expected loudness in said second sound, one or more level-dependent filters of said processing.

According to an embodiment of the invention said second processed audio signal is acoustically reproduced in said acoustical environment by said loudspeaker system.

Thereby a processed version of the second input audio signal may be acoustically reproduced in the acoustical environment. By virtue of the processing of the second input audio signal, it is primarily the intended listener(s) within the acoustical environment, such as the first sound zone, that perceive the reproduced audio signal, whereas other persons present in the acoustical environment that are not intended listeners do not perceive, or at least does not substantially perceive, the reproduced audio signal.

According to an embodiment of the invention said second processed audio signal is acoustically reproduced targeting said second sound zone.

Thereby a processed version of the input audio signal may be acoustically reproduced for the second sound zone. By virtue of the processing of the input audio signal, it is primarily the intended listener(s) within the second sound zone that perceive the reproduced audio signal.

According to an embodiment of the invention said first input audio signal and said second input audio signal are different input audio signals.

As an example, the first input audio signal may be an audio signal comprising music and the second input audio signal may be a speech signal such as a narration of a book.

According to an embodiment of the invention said expected loudness in said first sound zone is determined on the basis of one or more recordings of said second reproduced audio signal, said one or more recordings being performed with respect to said first sound zone.

According to an embodiment of the invention said one or more recordings of said second reproduced audio signal is performed using a microphone.

According to an embodiment of the invention said microphone is positioned within said first sound zone.

Placing a microphone within the first sound zone is advantageous in that the measurements/recordings by the microphone may represent, as best as possible, the actual sound pressure levels experienced in the first sound zone, and thereby the actual loudness experienced in the first sound zone.

According to an embodiment of the invention said expected loudness in said first sound zone is determined on the basis of an acoustic transfer function.

According to an embodiment of the invention said processing said second input audio signal comprises filtering harmonics in a directionally controllable frequency band, each of said harmonics corresponding to a lower order harmonic in a bass frequency band of said second input audio signal, wherein said bass frequency band comprises frequencies below said directionally controllable frequency band.

The second input audio signal may be processed in the same manner as the first input audio signal is processed according to any of the above provisions relating to filtering harmonics in a directionally controllable frequency band.

According to an embodiment of the invention said step of processing said input audio signal is performed by one or more signal processors.

In the context of the present invention, a “signal processor” is understood as any kind of processor capable of digital or analogue processing of an audio signal.

According to an embodiment of the invention said step of determining an expected loudness is performed by one or more signal processors.

The step of processing the input audio signal to produce a processed audio signal and the step determining an expected loudness may both be performed using signals processors, e.g., a common signal processor.

According to an embodiment of the invention said one or more signal processors comprises one or more digital signal processors.

Another aspect of the invention relates to a loudspeaker system for processing an input audio signal to be perceived in an acoustical environment comprising at least a first sound zone and a second sound zone, comprising:
an input arranged to receive an input audio signal;
one or more signal processors arranged to process said input audio signal to produce a processed audio signal; and
one or more transducers for acoustically reproducing said processed audio signal;
wherein said loudspeaker system is arranged to determine an expected loudness in a second sound zone of said acoustical environment, of acoustically reproducing said processed audio signal for a first sound zone of said acoustical environment, wherein said determining an expected loudness is at least with respect to a bass frequency band; and
wherein said loudspeaker system is arranged to automatically adjust one or more level-dependent filters of said processing on the basis of said determined expected loudness.

Thereby is provided an advantageous loudspeaker system which may acoustically reproduce an input audio signal for a first sound zone of an acoustical environment and ensure that leakage of sound into a second sound zone of the acoustical environment is reduced.

In the context of the present invention, a “signal processor” is understood as any kind of processor capable of digital or analogue processing of an audio signal.

According to an embodiment of the invention said input is arranged to receive a plurality of input audio signals including a first input audio signal and a second input audio signal.

The input of the loudspeaker system may be able to handle two input audio signals, such as a first input audio signal and a second input audio signal. The two input audio signals may be different input audio signals with respect to signal content. This is advantageous in that the loudspeaker system may acoustically reproduce two different input audio signals for two respective different sound zones of an acoustical environment.

According to an embodiment of the invention said loudspeaker system comprises one or more microphones.

The loudspeaker system may comprise a single microphone, for example a microphone in the second sound zone for performing one or more recordings of the reproduced processed audio signal, which recordings may be used as a basis for determining the expected loudness. The loudspeaker system may also include a further microphone in the first sound zone for performing one or more recordings of a reproduced second processed audio signal, which recordings may be used as a basis for determining a second expected loudness.

According to an embodiment of the invention said one or more signal processors comprises one or more digital signal processors.

According to an embodiment of the invention said loudspeaker system comprises a loudspeaker array comprising a plurality of transducers.

According to an embodiment of the invention said loudspeaker system is arranged to carry out any steps of a method according to any of the provisions described in the above.

Thereby the loudspeaker system has the same advantages described in relation to the provisions of the method according to the present invention.

According to an embodiment of the invention said loudspeaker system comprises any system related features according to any of the provisions described in the above.

### THE DRAWINGS

Various embodiments of the invention will in the following be described with reference to the drawings where

FIG. 1 illustrates an embodiment of the invention where a reproduced audio signal is targeted a first sound zone of an acoustical environment and the leakage of sound into a neighboring sound zone is taken into account,

FIG. 2 illustrates a method according to an embodiment of the invention,

FIG. 3 illustrates an example of radiation characteristics of a line source,

FIG. 4 illustrates a graph of equal loudness contours,

FIG. 5 illustrates a graph of loudness versus level which shows how the threshold of audibility is affected by a masking signal of different sound pressure levels,

FIG. 6 illustrates three masking signals of the same level applied at different center frequencies and how these affect the threshold of audibility,

FIG. 7 illustrates various masking signals of different levels applied at a same frequency and how these affect the threshold of audibility,

FIG. 8 illustrates an example of a processing and reproduction of an input audio signal according to an embodiment of the present invention,

FIG. 9 illustrates an example of a processing and reproduction of an input audio signal according to another embodiment of the present invention,

FIG. 10 illustrates an example of a processing and reproduction of an input audio signal according to yet another embodiment of the present invention,

FIG. 11 shows an embodiment of the invention, which is an alternative to the embodiment shown in FIG. 10,

FIG. 12 shows an embodiment of the invention, which is an alternative to the embodiment shown in FIG. 10, where the loudspeaker system comprises a loudspeaker array,

FIG. 13 shows an embodiment of the invention wherein two input audio signals are reproduced for two respective sound zones of the acoustical environment,

FIGS. 14a-b illustrates a transducer array of a loudspeaker system according to an embodiment of the invention,

FIG. 15 illustrates an example of an input audio signal according to embodiments of the present invention, and

FIG. 16 shows a principle of filtering harmonics in a directionally controllable frequency band as used according to embodiments of the present invention.

### DETAILED DESCRIPTION

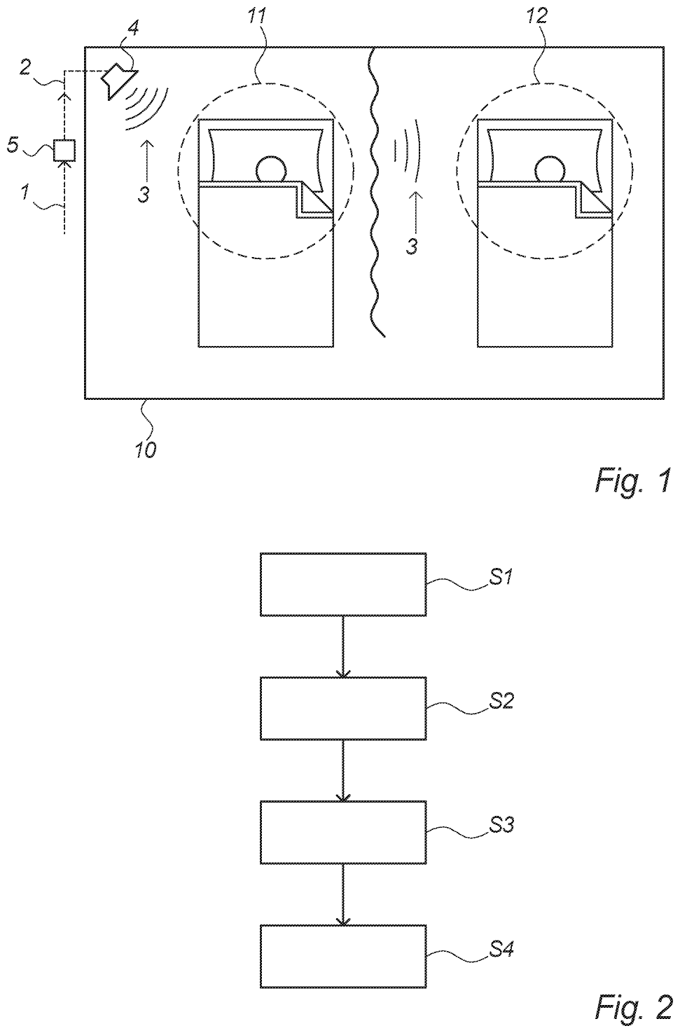

FIG. 1 illustrates an embodiment of the present invention. The figure shows an acoustical environment 10, which is a hospital bed ward comprising two bed spaces. However, in other embodiments of the invention, the acoustical environment 10 may be another environment than a hospital bed ward, such as an office space or even an outdoor environment such as an outdoor venue. As seen, the acoustical environment 10 of this embodiment comprises two distinct sound zones: a first sound zone 11 and a second sound zone 12. The two sound zones are seen to be spatially arranged in the acoustical environment 10 and are furthermore spatially non-overlapping. The first sound zone 11 is concentrated around a patient lying in a first bed space and the second sound zone 12 is concentrated around another patient lying in a neighboring second bed space. As seen in FIG. 1, the two bed spaces are separated by a curtain providing privacy to each of the two patients.

One of the bed spaces is provided with a loudspeaker system 4 comprising a signal processor 5 arranged to process an input audio signal 1 to produce a processed audio signal 2. The loudspeaker system 4 is further arranged to acoustically reproduce the processed audio signal 2 as a reproduced processed audio signal or put simply, a reproduced audio signal 3. As seen in FIG. 1, the loudspeaker system 4 is arranged to target the first sound zone 11, such that the patient present in the first sound zone 11 becomes the primary recipient of the acoustically reproduced audio signal 3.

Although the reproduced audio signal 3 is targeting the first sound zone 11 it may in practice be difficult to control exactly where in the acoustical environment 10 the reproduced audio signal 3 is present and where it is not. Therefore, as shown in FIG. 1, the reproduced audio signal 3 may also unintentionally be present in the second sound zone 12. In other words, there is a leakage of sound into the second sound zone 12, and this may be disturbing to the patient in the second sound zone if he/she is not an intended listener of the reproduced audio signal 3. Whether the signal is disturbing to the person in the second sound zone 12 depends on the perceived loudness of the signal in the second sound zone 12. Leakage of sound may be very difficult to control as it is a physical phenomenon occurring when sound waves travel through the air, however, loudness is an audiological phenomenon which is possible to take advantage of. Even though there may be a sound leakage into the second sound zone 12, it may not be possible to the person in the second sound zone 12 to discern the reproduced audio signal, if the sound pressure level of the reproduced audio signal 3 is at an adequately low level. This phenomenon is utilized in the present embodiment of the invention, as well as other embodiments of the invention.

FIG. 2 illustrates an embodiment of the invention. The figure shows steps S1-S4 of a method for processing an input audio signal 1 to be perceived in an acoustical environment 10 comprising at least a first sound zone 11 and a second sound zone 12. The acoustical environment 10 may be a hospital bed ward as shown for example in FIG. 1, however the acoustical environment 10 is not limited to this example.

In a first step S1, an input audio signal 1 is received. The input audio signal may be received in an input of a loudspeaker system 4. The input audio signal 1 may be any kind of electrical audio signal intended for reproduction. The input audio signal 1 may be an analogue or a digital audio signal. The input audio signal 1 may include any type of audio content to be reproduced, such as speech, music, and other kinds of sounds, e.g., sound alerts and notifications.

In a second step S2, the input audio signal 1 is processed using signal processing to generate a processed audio signal 2.

In a third step S3 is determined an expected loudness in a second sound zone 12 of the acoustical environment 10 of acoustically reproducing the processed audio signal 2 by a loudspeaker system 4 for a first sound zone 11 of the acoustical environment 10, wherein the determining is at least with respect to a bass frequency band 15 comprising frequencies below 700 Hz. Thereby, at least low frequency audio content that is difficult to control the directionality of is taken into account by the present method.

In a fourth step S4, one or more level-dependent filters of the processing referred to in the second step S2 are automatically adjusted on the basis of the determined expected loudness the second sound zone 12.

Thereby is provided a method where an input audio signal 1 is processed in such a way that a reproduction of the processed audio signal as a reproduced audio signal 3 is substantially perceived in a first sound zone 11 while avoiding too much disturbance in a neighboring sound zone 12. Referring back to FIG. 1, this method may enable the patient in the first sound zone 11 to listen music from the loudspeaker system 4 without disturbing the other patient in the neighboring sound zone 12 too much, as the expected loudness in the second zone 12 of reproducing the processed audio signal 2 in the first sound zone 11 is factored in, through adjustment(s) of level dependent filters, in the processing of the input audio signal 1.

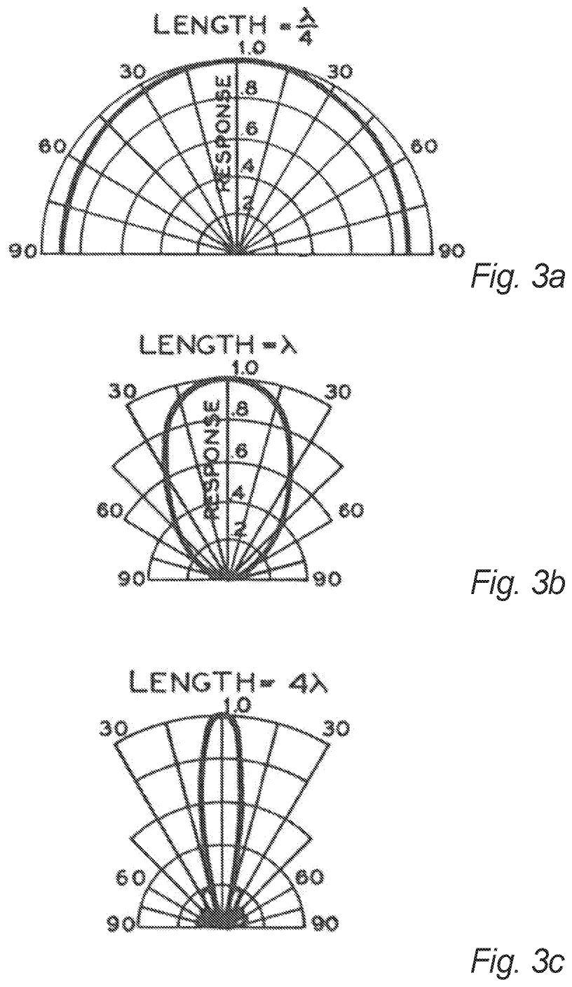

Sound leakage is a problem which is most predominant for low-frequency sounds since these are more difficult to control the directionality of than higher frequency sounds. This is demonstrated by FIGS. 3a-c which show directional characteristics of line sources of different lengths, expressed as multiples of the wavelength, λ (lambda), of a signal (normalised response=1 at the main lobe). A line source, as opposed to a point source, is a source that emanates from a linear geometry. In FIGS. 3a-c, the line sources are placed along the horizontal axis of the diagrams. The directional characteristics are three-dimensional and may be visualized by rotation of the shown characteristics around the horizontal axis.

FIG. 3a shows the radiation pattern (radiation lobe) of a line source having a length equal to one fourth of the wavelength λ of the signal, FIG. 3b shows the radiation pattern of a line source having a length equal to the wavelength λ of the signal, and FIG. 3c shows the radiation pattern of a line source having a length equal to four times the wavelength λ of the signal. When comparing these figures, it becomes clear that the width of radiation increases when the length of the source gets smaller compared to the wavelength of the signal.

For the purpose of the present invention, FIGS. 3a-c are best understood by considering a line source having a fixed length, and then assuming that the figures show directional characteristics for three different single-frequency audio signals reproduced by that line source, such as sinusoidal signals. In this case, FIG. 3a illustrates the single-frequency signal having the highest wavelength (lambda), i.e., the lowest frequency, whereas FIG. 3c illustrates the single-frequency signal having smallest wavelength (lambda), i.e., the highest frequency. When considering the frequency differences between the signals of e.g., FIGS. 3a-c, it becomes clear that for a line source the radiation lobe is narrower for higher frequencies than for lower frequencies. In other words, higher frequency signals are inherently more directional in space as opposed to lower frequency signals that exhibit more omnidirectional radiation characteristics.

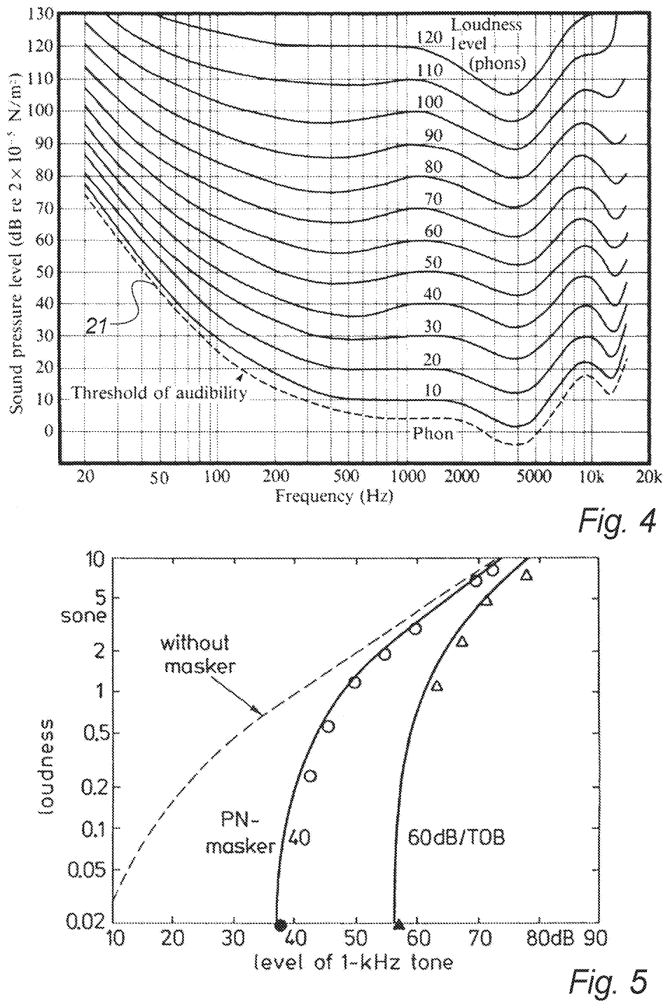

The human ear's sensitivity to sound at different frequencies can be described by so-called equal-loudness contours, also standardized by ISO. These contours/curves are illustrated in FIG. 4. The curves describe the physical intensity, in terms of sound pressure level, SPL, that a pure tone at different frequencies should have to be of the same perceived loudness level, measured in phons, as a pure tone at 1 kHz. From FIG. 4 it is apparent that the sensitivity of the human ear to lower and very high frequencies is lower than the sensitivity to middle frequencies around 1 kHz.

Furthermore, it should be noted that the human ear is relatively insensitive to bass, especially at low levels. At high levels the ear is approximately equally sensitive to all frequencies, however. This means that there is less physical dynamic range in bass (compared to medium and high frequencies) for full perceptual dynamic range. A change in physical level at low frequencies, such as in the bass frequency band, will have a greater impact on the perceived loudness than the same amount of physical level change at middle frequencies.

The lowest, dashed, curve in FIG. 4 is the threshold of audibility 21 (or threshold of hearing) and it plays an important role in the present invention. Below the threshold of audibility, sounds are basically inaudible. The transition between audible and inaudible as a function of physical sound pressure level is illustrated by the dashed curve in FIG. 5 where the perceived loudness of a 1 kHz tone is shown as a function of the physical sound pressure level. The threshold of audibility lies around 0.02 sone for this signal. As it is seen, the threshold of audibility is not a step function but rather a steep part of a curve which is approximately linear over a large dynamic range (when expressed on a logarithm of loudness vs. sound pressure level). When another sound, a so-called masker, is present, the curve becomes even steeper at low perceived levels, and the threshold of audibility, called the masked threshold in this case, increases proportionally with the level of the masker. The steepness of the loudness function indicates that it only takes a small change in physical level to change the perceived level considerably. FIG. 5 illustrates two different maskers, or masking signals, each comprising pink noise at two different levels: 40 dB and 60 dB per third-octave band (TOB) respectively. Such maskers, or masking signals, are used according to embodiments of the present invention.

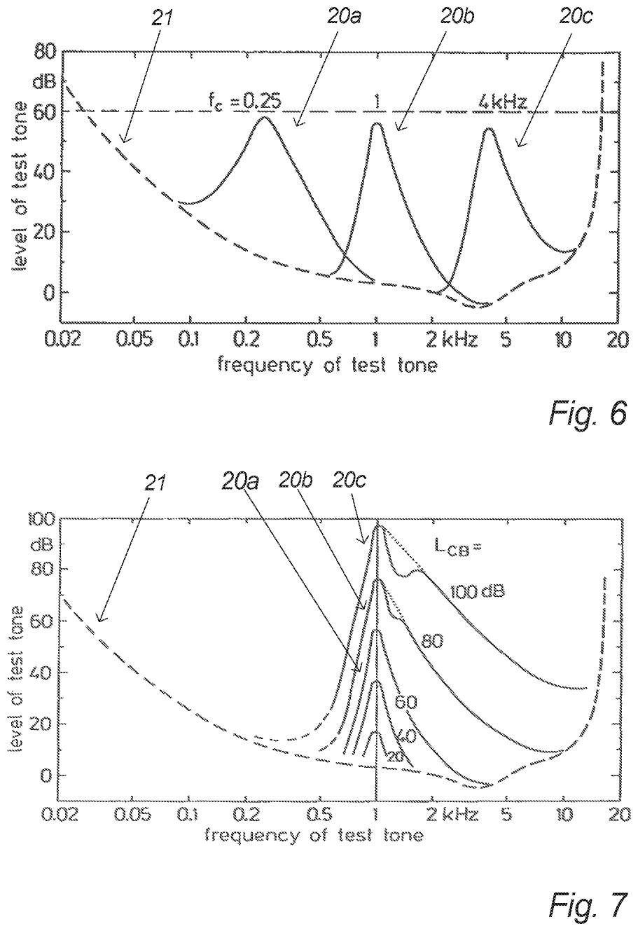

FIG. 6 demonstrates effects of a masking signal, or masker, as used in accordance with an embodiment of the invention. The figure illustrates the level (in dB) of a test tone in the frequency range from 20 Hz to 20 kHz. The test tone is masked by critical-band wide noise with level of 60 dB, and centre frequencies of 250 Hz, 1 kHz and 4 kHz. The broken curve represents the threshold of audibility 21. It is worth noticing that two effects are provided by a masking signal, and these are clearly seen in the figure:
1) The masking signal raises the level at which the test zone is perceived. In the present figure is seen how the level is almost raised to the 60 dB level of the masking signals. Consider for example the test tone at 250 Hz. Without the presence of the masking signal 20a having a centre frequency at 250 Hz the test tone may be perceived at around 12 dB, however when the masking signal 20a is present, the tone must be present at a level of almost 60 dB to be perceived. That is, the masking signal 20a has effectively raised the threshold for perceiving the test tone at 250 Hz. The same is also seen for the test tone at 1 kHz, where the other masking signal 20b is present, and for the test tone at 4 kHz where the last masking signal 20c is present.
2) The masking effect provided by a masking signal 20a-20c is present in a frequency band around the centre frequency of the masking signal 20a-20c. That is, a masking signal may provide a masking effect to a range of frequencies in the signal.

FIG. 7 demonstrates a similar figure to FIG. 6, however the various masking signals shown are all located at the same center frequency. For example, the graph includes a first masking signal 20a at a level of 100 dB, a second masking signal at a level of 80 dB, and a third masking signal at a level of 60 dB. As seen, each of these masking signal provide a masking effect which extends in a frequency range about the centre frequency, and the threshold of audibility increases proportionally with the level of the masking signals, with the highest threshold of audibility achieved by the first masking signal 20a, and consequently lower thresholds for the second masking signal 20b and the third masking signal 20c.

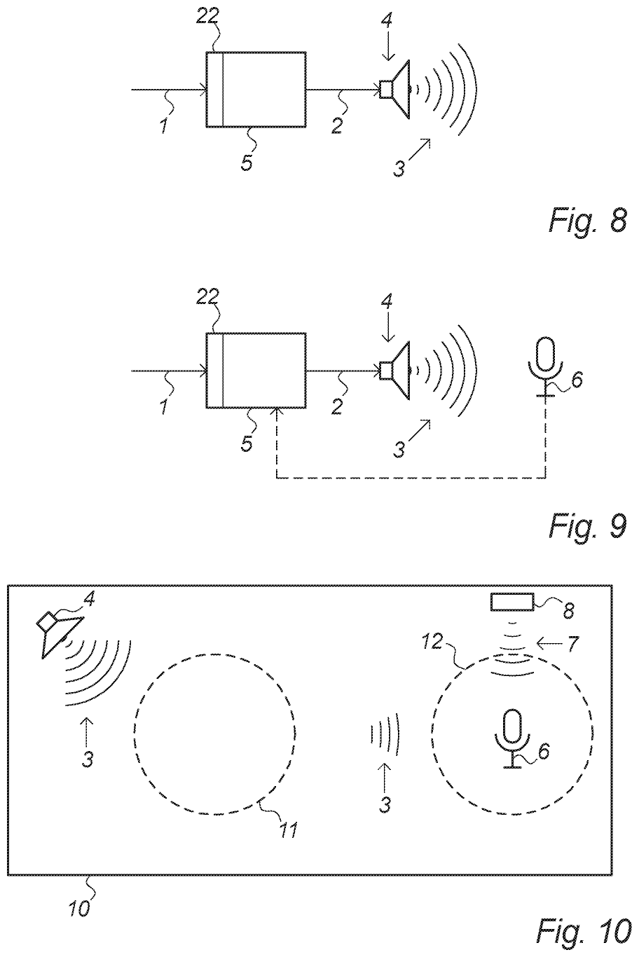

FIG. 8 illustrates an example of a processing and reproduction of an input audio signal 1 according to an embodiment of the present invention. This is an example of an open loop processing of the input audio signal 1, where the input audio signal 1 is received in an input 22 of a loudspeaker system 4 and is processed in a signal processor 5 to produce a processed audio signal 2 that is reproduced as a reproduced audio signal 3 by a loudspeaker system 4. Although the input 22 and the signal processor 5 is shown as separate entities to the loudspeaker system 4, a skilled person would easily recognize that the input 22 and the signal processor 5 forms part of the loudspeaker system 4.

In this embodiment of the invention, an expected loudness, in a second sound zone 12, of reproducing the processed audio signal 2 for a first sound zone 11, using a loudspeaker system 4, is established through estimation. This estimation is performed using a transfer function (not shown in the figure) which defines a relationship between a sound pressure level at the source, e.g., at a transducer of the loudspeaker system 4, and the sound pressure level at some remote point, e.g., in the second sound zone. Hereby, it is possible to determine a corresponding loudness in said second sound zone 12 of the reproduced audio signal 3 which is targeting the first sound zone 11. The processing shown in FIG. 8 is referred to as an open loop processing as the adjustment of level-dependent filters of the processing by the signal processor 5 is made based upon assumptions of the loudness of the reproduced audio signal 3 in the second sound zone 12, and not on the basis of recordings of the signal.

FIG. 9 illustrates an example of a processing and reproduction of an input audio signal 1 according to another embodiment of the present invention. This is an example of a closed loop processing of the input audio signal 1, where the input audio signal 1 is received in an input 22 and is processed in a signal processor 5 to produce a processed audio signal 2 that is reproduced as a reproduced audio signal 3 by a loudspeaker system 4. In this embodiment of the invention, an expected loudness, in the second sound zone 12, of reproducing the processed audio signal 2 for the first sound zone 11, using a loudspeaker system 4, is established through measurement. As seen in FIG. 9, a microphone 6 is communicatively associated with the signal processor 5, and this microphone 6 may perform one or more recordings of the reproduced audio signal 3 in the second sound zone 12. Thereby a sound pressure level of the reproduced audio signal 3 may be determined with respect to the second sound zone 12, and by use of a conversion model, this may be translated into an expected loudness with respect to the second sound zone 12. The processing shown in FIG. 9 is referred to as a closed loop processing as the adjustment of level-dependent filters of the processing by the signal processor 5 is made in response to the recordings of the reproduced audio signal 3.

Although FIGS. 8 and 9 illustrate the signal processor 5 and the loudspeaker system 4 as separate entities, the signal processor 5 may be integrated within the loudspeaker system 4, optionally along with one or more amplifiers (not shown in FIGS. 6 and 7).

The processing shown in FIGS. 8 and 9 may advantageously make use of the threshold of audibility as illustrated in FIG. 4. As an example, the level-dependent filters for the processing of the input audio signal 1 may be adjusted such that reproduction of low frequency content, such as frequencies in a bass frequency band of from 0 Hz to 300 Hz, for the first sound zone 11 are such that a corresponding sound pressure level in the second sound zone 12 is below the threshold of audibility. Thereby, at least the low-frequency content of the reproduced audio signal is substantially not perceived in the second sound zone 12. This is particular advantageous when the loudspeaker system 4 is able to directionally reproduce signal content at frequencies above the bass frequency band.

FIG. 10 illustrates another embodiment of the invention which builds on the embodiment shown in FIG. 9. As seen, the loudspeaker system 4, illustrated as a single transducer, is specifically targeting the first sound zone 11 of an acoustical environment 11 with the reproduced audio signal 3. The acoustical environment 10 may be an acoustical environment as shown in FIG. 1, however, the acoustical environment 10 may also be representative of other environments wherein an input audio signal 1 is to be reproduced by a loudspeaker system 4. As seen, in FIG. 10, there is a leakage of the reproduced audio signal 3 to the second sound zone 12, and this is recorded by the microphone 6 present in the second sound zone 12.

As seen in FIG. 10 an acoustic sound 7 is present within the second sound zone 12. The acoustic sound 7 is as sound that is different from the reproduced audio signal 3 and it originates from a foreign audio source 8. In this example, the foreign audio source 8 is a television, however, according to other embodiments of the invention the foreign audio source 8 may be any other source of acoustic sound other than the loudspeaker system 4. For example, the foreign audio source 8 may be a television which is viewed by the other patient in the second sound zone 12 as seen in FIG. 1.

As shown in FIG. 10, the microphone 6 also records the acoustic sound 7 stemming from the foreign audio source 8. This, however, does not exclude two distinct microphones being used; a first microphone 6 for recording the reproduced audio signal 3 and second microphone 6 (not shown in the figure) for recording the acoustic sound 7.

In the embodiment of the invention shown in FIG. 10, both the reproduced audio signal 3 and the acoustic sound 7 is recorded. Thereby, it is advantageously determined to what extent the acoustic sound 7 provides a masking effect to the reproduced audio signal 3 in the second sound zone 12.

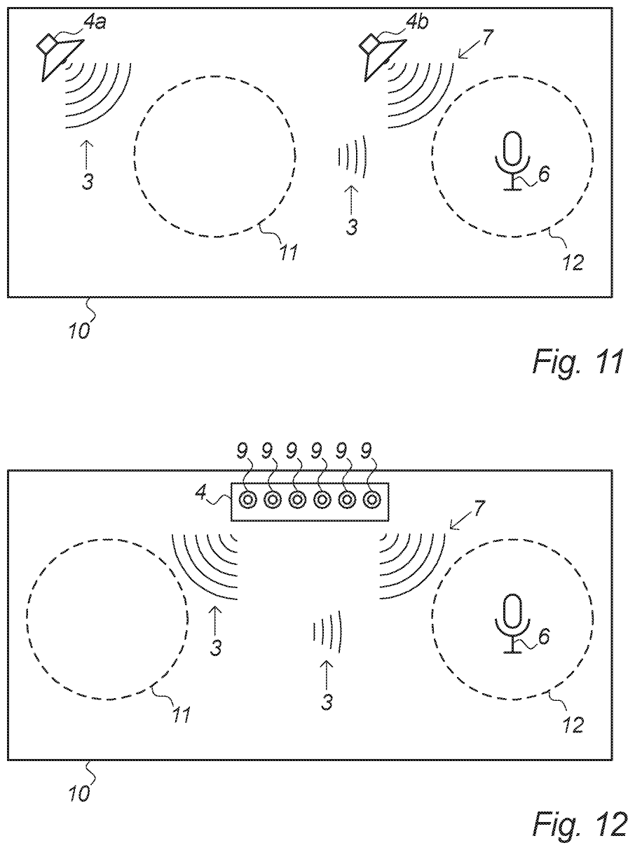

FIG. 11 shows an embodiment of the invention, which is an alternative to the embodiment of FIG. 10 where the loudspeaker system 4 comprises a first loudspeaker 4a and a second loudspeaker 4b. The first loudspeaker 4a is arranged to provide a reproduced audio signal 3 to the first sound zone, and the second loudspeaker 4b is arranged to produce acoustic sound 7. As opposed to the embodiment of FIG. 10 the acoustic sound 7 does not originate form a foreign audio source 8, but from the second loudspeaker 4b of the loudspeaker system 4 which means that the acoustic sound 7 is controllable by the loudspeaker system 4. In other embodiments of the invention, the loudspeaker system 4 may also be able to produce acoustic sound 7 for the second sound zone 12 without relying on loudspeakers that are spaced apart as seen in FIG. 11.

For example, according to another embodiment of the invention, the loudspeaker system 4 comprises a loudspeaker array 23 comprising a plurality of transducers 9.

In the embodiment of FIG. 11 the acoustic sound 7 is a masking signal, or masker, produced by the loudspeaker system 4. The masking signal ensures that a listener present in the second sound zone 12 is less affected by sound leakage from the first sound zone 11 into the second sound zone 12.

FIG. 12 shows an embodiment of the invention that is similar to the embodiment of FIG. 11, however, in this embodiment the loudspeaker system 4 comprises a loudspeaker array 23 made up of a plurality of transducers 9. The loudspeaker array 23 is particularly suitable for directionally reproducing sound and may for example be positioned in the acoustical environment 10 at a position which is equally spaced apart from the first sound zone 11 and the second sound zone 12, while still targeting the reproduced audio signal 3 towards the first sound zone 11. As seen in FIG. 12, the loudspeaker array 23 may also target the second sound zone 12 with acoustic sound 7 in the form of a masking signal.

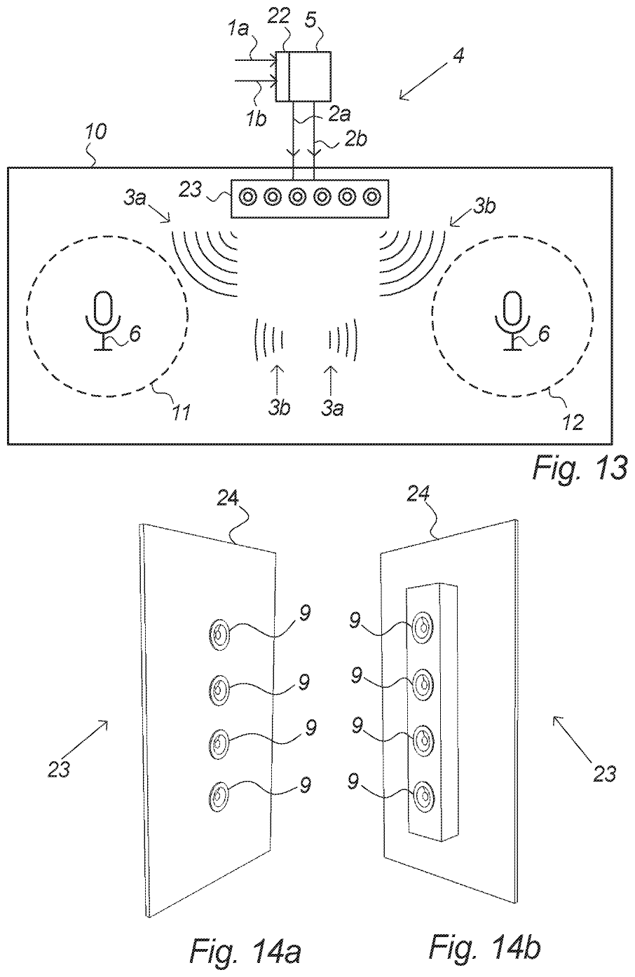

FIG. 13 shows an embodiment of the invention in which two input audio signals are provided to an input 22 of a loudspeaker system 4: a first input audio signal la and a second input audio signal lb. The two input signals are two different signals with respect to signal content. The signal processor is arranged to process the two input audio signals according to methods of the present invention to provide respective processed audio signals: a first processed audio signal 2a and a second processed audio signal 2b. As seen in FIG. 13 the loudspeaker system 4, which comprises a loudspeaker array 23 comprising a plurality of transducers 9, is arranged to reproduce the two processed audio signals 2a and 2b for respective sound zones. Thereby a first reproduced audio signal 3a is targeted the first sound zone 11 and a second reproduced audio signal 3b is targeted the second sound zone 12. The loudspeaker system may utilize the methods descried in the various embodiments of the invention to ensure that the undesired effects of sound leakage into respective sound zones are reduced/avoided. Thereby a listener present in the second sound zone 12 is not disturbed by the first reproduced audio signal 3a and a listener present in the first sound zone 11 is not disturbed by the second processed audio signal 3b. In FIG. 13 is shown that microphones 6 are used to determine expected loudness in the first sound zone 11 and the second sound zone 12, however according to another embodiment of the invention, the these expected loudness may be established using respective acoustic transfer functions.

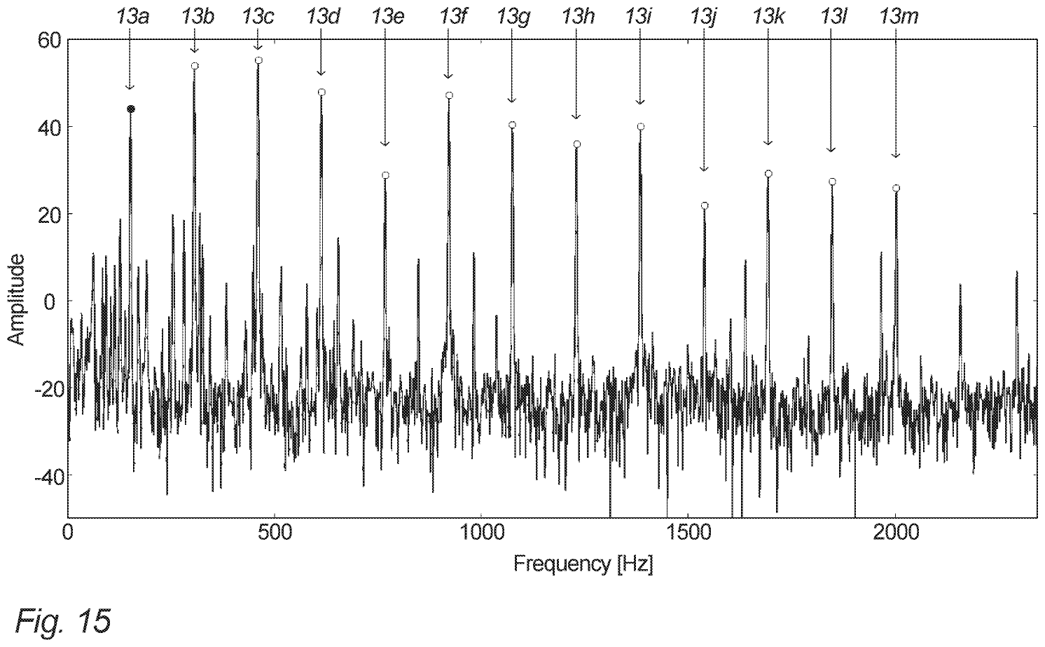

FIGS. 14a and 14b respectively illustrates a frontal view and a rear view of a loudspeaker array 23 which according to an embodiment of the invention may constitute the loudspeaker system 4. The loudspeaker array 23 comprises a number of gradient loudspeakers which are made up by a plurality of transducers 9. Each of the gradient loudspeakers comprises two respective transducers 9 which are placed on a baffle 24, such that radiation in opposite directions does not cancel in an unwanted way. FIGS. 14a and 14b shows just four sets of gradient loudspeakers, however it is to be understood that the loudspeaker array 23 can comprise any number of transducers 9 and gradient loudspeakers. In an alternative embodiment of the invention, a gradient loudspeaker is constructed by purely acoustic means by mounting the transducer in an enclosure with partly open back, e.g., by using a port, thereby letting the opening replace the second transducer/loudspeaker of the gradient loudspeaker. Use of such acoustic means, also referred to as gradient control elements throughout this disclosure, is well known in the art, both for loudspeakers and especially for microphones.

According to an embodiment of the invention, the loudspeaker system 4, when comprising a loudspeaker array as seen in FIGS. 12 and 13, utilizes bass substitution to further alleviate problems relating to sound leakage.

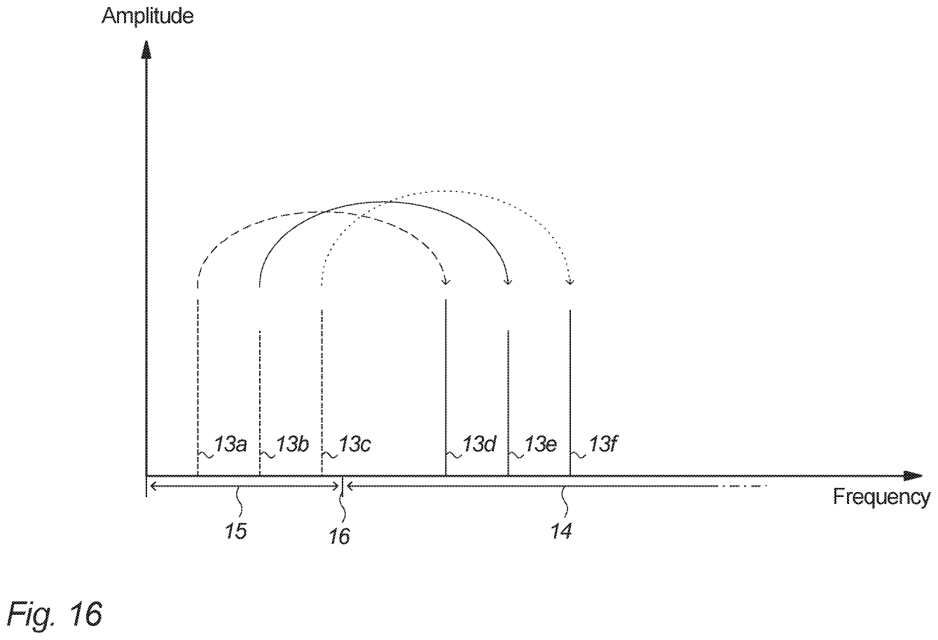

FIG. 15 illustrates an example of an input audio signal 1 according to embodiments of the present invention. This particular example is a sound produced by a bass guitar. The frequency spectrum shown in FIG. 15 illustrates the amplitude of various frequency components in the frequency range of between 0 Hz (Hertz) and approximately 2500 Hz. The amplitude is between around −50 and 60 (arbitrary units). Note the many harmonics 13a-13m which are integer multiples of the fundamental frequency 13a of 155 Hz in this case. Together the harmonics 13a-13m, when listened to by a listener, provides an auditory sensation of a low frequency sound with the timbre, i.e., tone colour, defined by the relative amplitudes of the harmonics 13a-13m. Overtones which are perfect integer multiples of the fundamentals are called harmonics. It is appropriate at this point to further elaborate on the meaning of harmonics. In the present disclosure the term “harmonic” refers to modes of vibration of a system that are whole-number multiples of a fundamental mode, and also to the sounds that they generate. However, it is customary to the skilled person to stretch the definition a bit so that it includes modes that are nearly whole-number multiples of the fundamental, for example 2.005 times the fundamental rather than 2. Thus, for the purpose of the present invention, the term “harmonics” encompasses both overtones that are perfect integer multiples of a fundamental, as well as overtones that are not exactly integer multiples of a fundamental. Such non-perfect harmonics may arise to e.g., stiffness in an instrument, for example due to a stiffness in a musical string such as a bass guitar.

A principle of virtual pitch occurs in the human hearing system. Virtual pitch is the fact that the lowest, or even several of the lowest harmonics can be removed while maintaining the perceived pitch of the signal, as the pitch information is carried by the frequency distance between the harmonics present in the signal. Pitch is closely related to frequency, however the two are not equivalent. Frequency is an objective, scientific attribute that can be measured. Pitch, however, is a person's subjective perception of a sound wave, which cannot be measured. However, this does not necessarily mean that most people won't agree on which notes are higher and lower. The pitch of a signal can be maintained even when low-order harmonics of the signal are removed, however, higher-order harmonics naturally must be present in order to utilize the phenomenon of virtual pitch.

In FIG. 16 is shown a principle of filtering harmonics in a directionally controllable frequency band 14 as used according to various embodiments of the present invention. Throughout the present disclosure, filtering harmonics in a directionally controllable frequency band 14 is also referred to simply as bass substitution.

FIG. 16 shows three low-order harmonics 13a-13c of an input audio signal 1. These three low-order harmonics 13a-13c are shown to be present in a bass-frequency band 15 of the signal 1. The bass frequency band 15 is understood as a range of frequencies of sound comprising the tones of low frequency, i.e., the frequencies of sound that are concentrated around the lower end of audible sound, which generally for the human ear are frequencies of between 20 Hz and 20,000 Hz. As also seen in FIG. 16, another range of frequencies is also shown, and this frequency range is referred to as the directionally controllable frequency band 14. The directionally controllable frequency band 14 is understood as a range of frequencies of sound where the directionality of the sound is most easily controlled. As an example, a frequency of sound which when reproduced by a transducer/loudspeaker gives rise to a radiation characteristic as shown in FIG. 3a could be considered as a frequency present in the bass frequency band 15, whereas a frequency of sound which when reproduced by the same transducer/loudspeaker gives rise to a radiation characteristic as shown in FIG. 3c could be considered as a frequency present in a directionally controllable frequency band 14. The bass frequency band 15 and the directionally controllable frequency band 14 in FIG. 15 is separated by a border frequency 16, which in the present example is 500 Hz, however according to an embodiment of the invention, the border frequency 16 could be anywhere in between 200 Hz and 700 Hz. As the border frequency 16 is at 500 Hz this also entails that the three lower order harmonics 13a-13c in FIG. 14 could also be considered to be present in a bass frequency band 15.

The three low-order harmonics 13a-13c are represented by corresponding and higher order harmonics 13d-13f which are part of the same harmonic series as the lower-order harmonics 13a-13c. In particular, the higher order harmonics 13d-13f are represented by:
1) frequency shifting of the harmonics 13a-13c by an integer multiple of the lowest order harmonic 13a, also referred to as the fundamental, possibly in correlation with attenuation of the bass frequency band 15,
2) increasing a gain of one or more corresponding harmonics within the directionally controllable frequency band 14, possibly in correlation with attenuation of the bass frequency band 15, or
3) generating one or more corresponding harmonics within the directionally controllable frequency band 14 on the basis of one or more lower order harmonics, possibly in correlation with attenuation of the bass frequency band 15.

These three different ways of representing low-order harmonics by higher order harmonics are all considered as filtering harmonics in a directionally controllable frequency band 14 according to embodiments of the present invention.

Bass substitution, or filtering of harmonics in a directionally controllable frequency band is advantageous in combination with the method of the invention exemplified in for example FIG. 2. Depending on the acoustical environment 10 and arrangements of the first sound zone 11 and the second sound zone 12, it may be the case that the level-dependent filters must be adjusted in such a way that the sound pressure level of the reproduced audio signal 3 must be so low in the bass frequency band 15 in the first sound zone 11, to avoid disturbances in the second sound zone 12, that the sensation of bass frequency sound is severely hampered in the first sound zone 11. By performing bass substitution, it is possible to represent the low frequency content of the input audio signal 1 with higher-order harmonics 13d-13f in the directionally controllable frequency band 14 and thereby make use of the phenomenon of virtual pitch to ensure that an improved sensation of bass frequency sounds is achieved by a listener present in the first sound zone 11.

### LIST OF REFERENCE SIGNS

1 Input audio signal
1a First input audio signal
1b Second input audio signal
2 Processed audio signal
2a First processed audio signal
2b Second processed audio signal
3 Reproduced audio signal
3a First reproduced audio signal
3b Second reproduced audio signal
4 Loudspeaker system
4a-4b Loudspeaker of loudspeaker system
5 Signal processor
6 Microphone
7 Acoustic sound
8 Foreign audio source
9 Transducer of loudspeaker system
10 Acoustical environment
11 First sound zone
12 Second sound zone
13a-m Harmonics
14 Directionally controllable frequency band
15 Bass frequency band
16 Border frequency
20a-c Masking signal
21 Threshold of audibility
22 Input
23 Loudspeaker array
24 Baffle
S1-S4 Method steps

1. A method for processing an input audio signal to be perceived in an acoustical environment comprising at least a first sound zone and a second sound zone, said method comprising steps of:
receiving an input audio signal;
processing said input audio signal using signal processing to generate a processed audio signal;
determining an expected loudness in a second sound zone of said acoustical environment, of acoustically reproducing said processed audio signal loudspeaker system for a first sound zone of said acoustical environment, wherein said determining an expected loudness is at least with respect to a bass frequency band; and
automatically adjusting, on the basis of said determined expected loudness in said second sound zone, one or more level-dependent filters of said processing.

2. The method according to claim 1, wherein said method comprises a step of determining a second expected loudness of acoustic sound present in said second sound zone, and wherein said automatically adjusting one or more level-dependent filter is further based on said second expected loudness level.

3. The method according to claim 2, wherein said acoustic sound present in said second sound zone is produced by a foreign audio source different from said loudspeaker system.

4. The method according to claim 2, wherein said acoustic sound present in said second sound zone is produced by said loudspeaker system on the basis of a received second input audio signal.

5. (canceled)

6. The method according to claim 4, wherein said second input audio signal is a masking signal.

7-12. (canceled)

13. The method according to claim 1, wherein said processed audio signal is first reproduced at a first sound pressure level in said first sound zone and subsequently reproduced at a second sound pressure level in said first sound zone, wherein said second sound pressure level is different from said first sound pressure level.

14. (canceled)

15. The method according to claim 1, wherein said expected loudness in said second sound zone is determined on the basis of one or more recordings of said reproduced audio signal, said one or more recordings being performed with respect to said second sound zone.

16-17. (canceled)

18. The method according to claim 1, wherein said expected loudness in said second sound zone is determined on the basis of an acoustic transfer function.

19. (canceled)

20. The method according to claim 2, wherein said second expected loudness in said second sound zone is determined on the basis of one or more recordings of said acoustic sound present in said second sound zone, said one or more recordings being performed with respect to said second sound zone.

21. (canceled)

22. The method according to claim 1, wherein said bass frequency band comprises frequencies in the range of from 0 Hz to 700 Hz.

23-24. (canceled)

25. The method according to claim 1, wherein said loudspeaker system comprises a loudspeaker array, said loudspeaker array comprising a plurality of transducers, and wherein said step of acoustically reproducing said input audio signal comprises generating a plurality of driving signals, wherein each driving signal is generated for a respective transducer of said loudspeaker array.

26. The method according to claim 25, wherein said loudspeaker array comprises one or more gradient loudspeakers.

27-30. (canceled)

31. The method according to claim 1, wherein said processing said input audio signal comprises filtering harmonics in a directionally controllable frequency band, each of said harmonics corresponding to a lower order harmonic in a bass frequency band of said input audio signal, wherein said bass frequency band comprises frequencies below said directionally controllable frequency band.

32. The method according to claim 1, wherein said processing said input audio signal comprises attenuating said bass frequency band of said input audio signal.

33-43. (canceled)

44. The method according to claim 1, wherein said input audio signal is a first input audio signal, said processed audio signal is a first processed audio signal, and wherein said method further comprises the steps of:
receiving a second input audio signal;
processing said second input audio signal by signal processing to generate a second processed audio signal;
determining an expected loudness in said first sound zone of said acoustical environment, of reproducing said second processed audio signal by said loudspeaker system for said second sound zone of said acoustical environment, wherein said determining an expected loudness is at least with respect to a bass frequency band, and
automatically adjusting, on the basis of said determined expected loudness in said first sound zone one or more level-dependent filters of said processing.

45-47. (canceled)

48. The method according to claim 44, wherein said expected loudness in said first sound zone is determined on the basis of one or more recordings of said second reproduced audio signal, said one or more recordings being performed with respect to said first sound zone.

49-50. (canceled)

51. The method according to claim 44, wherein said expected loudness in said first sound zone is determined on the basis of an acoustic transfer function.

52-55. (canceled)

56. A loudspeaker system for processing an input audio signal to be perceived in an acoustical environment comprising at least a first sound zone and a second sound zone, comprising:
an input arranged to receive an input audio signal;
one or more signal processors arranged to process said input audio signal to produce a processed audio signal; and
one or more transducers for acoustically reproducing said processed audio signal;
wherein said loudspeaker system is arranged to determine an expected loudness in a second sound zone of said acoustical environment, of acoustically reproducing said processed audio signal for a first sound zone of said acoustical environment, wherein said determining an expected loudness is at least with respect to a bass frequency band; and
wherein said loudspeaker system is arranged to automatically adjust one or more level-dependent filters of said processing on the basis of said determined expected loudness.

57-59. (canceled)

60. The loudspeaker system according to claim 56, wherein said loudspeaker system comprises a loudspeaker array comprising a plurality of transducers.

61-62. (canceled)

63. A method for processing an input audio signal to be perceived in an acoustical environment comprising at least a first sound zone and a second sound zone, said method comprising steps of:
receiving an input audio signal;
processing said input audio signal using signal processing to generate a processed audio signal, wherein said processing said input audio signal comprises filtering harmonics in a directionally controllable frequency band, each of said harmonics corresponding to a lower order harmonic in a base frequency band of said input audio signal, wherein said bass frequency band comprises frequencies below said directionally controllable frequency band;
determining an expected loudness in a second sound zone of said acoustical environment, of acoustically reproducing said processed audio signal by a loudspeaker system for a first sound zone of said acoustical environment, wherein said determining an expected loudness is at least with respect to a bass frequency band;
automatically adjusting, on the basis of said determined expected loudness in said second sound zone, one or more level-dependent filters of said processing; and
wherein said loudspeaker system comprises a loudspeaker array comprising a plurality of transducers, and wherein said loudspeaker array comprises one or more gradient loudspeakers.
